(19) United States
(12) Patent Application Publication
(10) Pub. No.: US 2011/0080909 A1
(43) Pub. Date: Apr. 7, 2011

(54) METHOD AND APPARATUS FOR CONTROLLING RECEIVING IP MULTICAST SERVICES BASED ON NETWORK

(75) Inventors: Nam Seok KO, Daejeon (KR); Soon Seok LEE, Daejeon (KR); Yoo Hwa KANG, Daejeon (KR); Sung Kee NOH, Daejeon (KR); Hea Sook PARK, Daejeon (KR); Sung Back HONG, Daejeon (KR)

(73) Assignee: Electronics and Telecommunications Research Institute, Daejeon (KR)

(21) Appl. No.: 12/889,291

(22) Filed: Sep. 23, 2010

(30) Foreign Application Priority Data
Oct. 1, 2009 (KR) 10-2009-0093799
Aug. 25, 2010 (KR) 10-2010-0082547

(51) Int. Cl. H04L 12/56

(52) U.S. Cl. 370/390

(57) ABSTRACT

Provided is a network-based Internet Protocol (IP) multicast service reception controlling apparatus and method. Data corresponding to a multicast channel may be controlled based on a snooping table. The snooping table may be updated based on the service profile. The snooping table may be updated based on a control message, and the control message may be based on whether a user is subscribed to the multicast channel. Whether data corresponding to the multicast channel is to be transmitted may be determined based on whether the data is being transmitted to another user in response to a request from the other user.

### CROSS-REFERENCE TO RELATED APPLICATION

This application claims the benefit of Korean Patent Application. Nos. 10-2009-0093799, filed on Oct. 1, 2009 and 10-2010-0082547, filed on Aug. 25, 2010, in the Korean Intellectual Property Office, the disclosure of which is incorporated herein by reference.

### BACKGROUND

1. Field of the Invention

The present invention relates to an IP multicast service reception controlling apparatus and method based on a network.

2. Description of the Related Art

A conditional access system (CAS) may be used to allow only an authorized user for a multicast channel to receive data from a corresponding channel. In a CAS with respect to an IP multicast service, such as an IPTV service, a system that transmits data corresponding to the multicast channel may perform scrambling or encoding of the corresponding data, and may distribute, to the authorized user, a key for descrambling or decoding the data corresponding to the multicast channel, to enable the authorized user to descramble or decode the data corresponding to the multicast channel.

### SUMMARY

An aspect of the present invention provides an IP multicast service reception controlling apparatus and method based on a network.

According to an aspect of the present invention, there is provided a multicast reception control switch, the multicast reception control switch including a memory to store a snooping table and a service profile including information associated with multicast channels to which each of a plurality of users is subscribed to, and a processor to determine, based on the service profile, whether a predetermined user is subscribed to a predetermined multicast channel, to update, in the snooping table, information associated with the predetermined user based on the determination, and to control, based on the snooping table, data corresponding to the predetermined multicast channel and being transmitted from a multicast router.

In response to a request from the predetermined user for using the predetermined multicast channel, the processor may determine, based on the service profile, whether the predetermined user is subscribed to the predetermined multicast channel.

The processor may request the multicast router to transmit the data corresponding to the predetermined multicast channel to the multicast reception control switch.

The processor may request the multicast router to transmit the data corresponding to the predetermined multicast channel to the multicast reception control switch based on whether the multicast reception control switch is currently receiving the data corresponding to the predetermined multicast channel from the multicast router.

The multicast router may transmit, based on the service profile and in response to a request from the multicast reception control switch, the data corresponding to the predetermined multicast channel to the multicast reception control switch.

According to an aspect of the present invention, there is provided a multicast reception control switch, the multicast reception control switch including a memory to store a snooping table, and a processor to update, in the snooping table, information associated with a predetermined user, in response to a request from the predetermined user for using a predetermined multicast channel, to control, based on the snooping table, data corresponding to the predetermined multicast channel, and to update the snooping table based on a control message to delete information associated with the predetermined user, the control message being received from a multicast router and being based on whether the predetermined user is subscribed to the predetermined multicast channel.

The processor may request the multicast router to transmit the data corresponding to the predetermined multicast channel to the multicast reception control switch, in response to the request from the predetermined user for using the predetermined multicast channel.

The processor may request the multicast router to determine whether the predetermined user is subscribed to the predetermined multicast channel based on whether the multicast reception control switch is currently receiving the data corresponding to the predetermined multicast channel from the multicast router.

The processor may receive the data corresponding to the predetermined multicast channel, based on a determination of the multicast router that determines whether the predetermined user is subscribed to the predetermined multicast based on a service profile including information associated with multicast channels to which each of a plurality of users is subscribed to.

According to an aspect of the present invention, there is provided a multicast router, the multicast router including a processor to determine whether a predetermined user is subscribed to a predetermined multicast channel, based on a service profile including information associated with multicast channels to which each of a plurality of users is subscribed to and in response to a request from the multicast reception control switch, the request being with respect to a predetermined multicast channel of the predetermined user, and a transmitting unit to transmit, based on the determination, data corresponding to the predetermined multicast channel to the multicast reception control switch.

The processor may generate a control message to delete, from the snooping table, information associated with the predetermined user when the predetermined user is not subscribed to the predetermined multicast channel, and the transmitting unit may transmit the control message to the multicast reception control switch.

The multicast router may further include a memory to store the service profile including the information associated with the multicast channels to which each of the plurality of users is subscribed to.

The memory may obtain the service profile from an external server that processes channel subscription requests of the plurality of users.

The request from the multicast reception control switch may be a request for transmitting the data corresponding to the predetermined multicast channel to the multicast reception control switch or a request for determining whether the predetermined user is subscribed to the predetermined multicast channel.

According to an aspect of the present invention, there is provided an IP multicast service reception controlling method using a multicast reception control switch, the method including updating, by the multicast reception control switch, information associated with a predetermined user in a snooping table of the multicast reception control switch, in response to a request from the predetermined user for using a predetermined multicast channel, determining, by the multicast router, whether the predetermined user is subscribed to the predetermined multicast channel, and transmitting data corresponding to the predetermined multicast channel to the multicast reception control switch based on the determination, and controlling, by the multicast reception control switch, the data corresponding to the predetermined multicast channel based on the snooping table.

The updating may include updating the snooping table based on whether the predetermined user is subscribed to the predetermined multicast channel, using the service profile including the information associated with multicast channels to which each of a plurality of users is subscribed to.

The IP multicast service reception controlling method may further include requesting, by the multicast reception control switch, the multicast router to transmit, to the multicast reception control switch, the data corresponding to the predetermined multicast channel.

The requesting may include requesting, by the multicast reception control switch, the multicast router to transmit, to the multicast reception control switch, the data corresponding to the predetermined multicast channel, based on whether the multicast reception control switch is currently receiving the data corresponding to the predetermined multicast channel from the multicast router.

The IP multicast service reception controlling method may further include transmitting, by the multicast router, a control message to the multicast reception control switch to delete information associated with the predetermined user from the snooping table, when the predetermined user is not subscribed to the predetermined multicast channel, and updating, by the multicast reception control switch, the snooping table based on the control message.

Additional aspects, features, and/or advantages of the invention will be set forth in part in the description which follows and, in part, will be apparent from the description, or may be learned by practice of the invention.

According to embodiments, data corresponding to a multicast channel may be controlled based on a snooping table and thus, access of a user that is not subscribed to the multicast channel may be blocked. Data may be transmitted to an authorized user by controlling of a network device, such as the multicast reception control switch and the multicast router and the like, without scrambling and descrambling or encoding and decoding.

According to embodiments, a multicast reception control switch updates a snooping table based on a service profile, in response to a request from a user for using a predetermined channel, and provides multicast data to an authorized user.

According to embodiments, a multicast reception control switch requests a multicast router to transmit data based on whether a predetermined multicast channel is currently being received, in response to a request from a user for using the predetermined multicast channel and thus, a message exchange between the multicast reception control switch and the multicast router may be reduced.

According to embodiments, a multicast router transmits a control message to a multicast reception control switch to delete the corresponding user, based on whether a user is subscribed to a predetermined multicast channel and thus, the multicast reception control switch may provide a multicast data service to an authorized user without a service profile.

### BRIEF DESCRIPTION OF THE DRAWINGS

These and/or other aspects, features, and advantages of the invention will become apparent and more readily appreciated from the following description of embodiments, taken in conjunction with the accompanying-drawings of which:

FIG. 1 is a diagram illustrating a system that controls reception of an Internet Protocol (IP) multicast service based on a network according to an embodiment of the present invention;

FIG. 2 is a diagram illustrating an example of controlling or reception of an IP multicast service when a multicast reception control switch includes a service profile and performs passive snooping;

FIG. 3 is a diagram illustrating an example of controlling of reception of an IP multicast service when a multicast reception control switch includes a service profile and performs active snooping;

FIG. 4 is a diagram illustrating an example of controlling of reception of an IP multicast service when a multicast reception control switch does not include a service profile and performs passive snooping;

FIG. 5 is a diagram illustrating an example of controlling of reception of an IP multicast service when a multicast reception control switch does not include a service profile and performs active snooping; and

FIG. 6 is a block diagram illustrating a multicast reception control switch.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

According to embodiments, data associated with an Internet Protocol (IP) multicast to channel to which a user is not subscribed to may be completely blocked using a multicast reception control switch. The multicast reception control switch may be a layer 2 (L2) switch or a layer 3 (L3) switch. The multicast reception control switch may exist between the user and a multicast router. The multicast router may be an L3 multicast router.

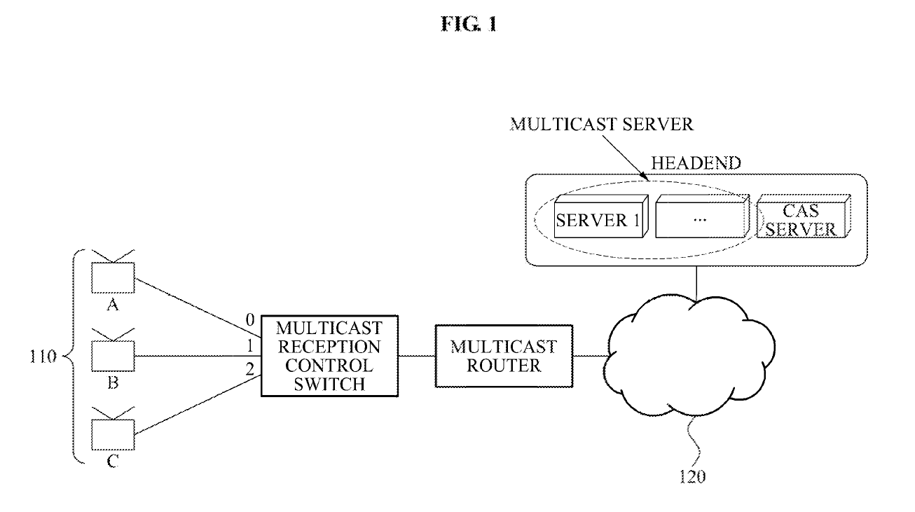

FIG. 1 illustrates a system that controls reception of an IP multicast service based on a network according to an embodiment of the present invention.

Referring to FIG. 1, data corresponding to each multicast channel may be transmitted, from a headend, to users 110, via a network 120, a multicast router, and a multicast reception control switch.

According to embodiments, the multicast reception control switch and the multicast router may be controlled to prevent a user that is not subscribed to a multicast channel from receiving a service of the corresponding multicast channel, without using a conditional access system (CAS). According to embodiments, the reception control switch and the multicast router may be controlled, so that only the user that is subscribed to the corresponding multicast channel is allowed to receive data associated with the corresponding multicast channel.

According to embodiments, the multicast reception control switch may perform snooping with respect to a multicast control message, such as a multicast reception request message, a multicast reception stop message, and the like, exchanged between the user and the multicast router for a multicast service. In a case of an Internet group management protocol (IGMP), the snooping may be performed with respect to a join request included in a membership report and a leave request included in the membership report.

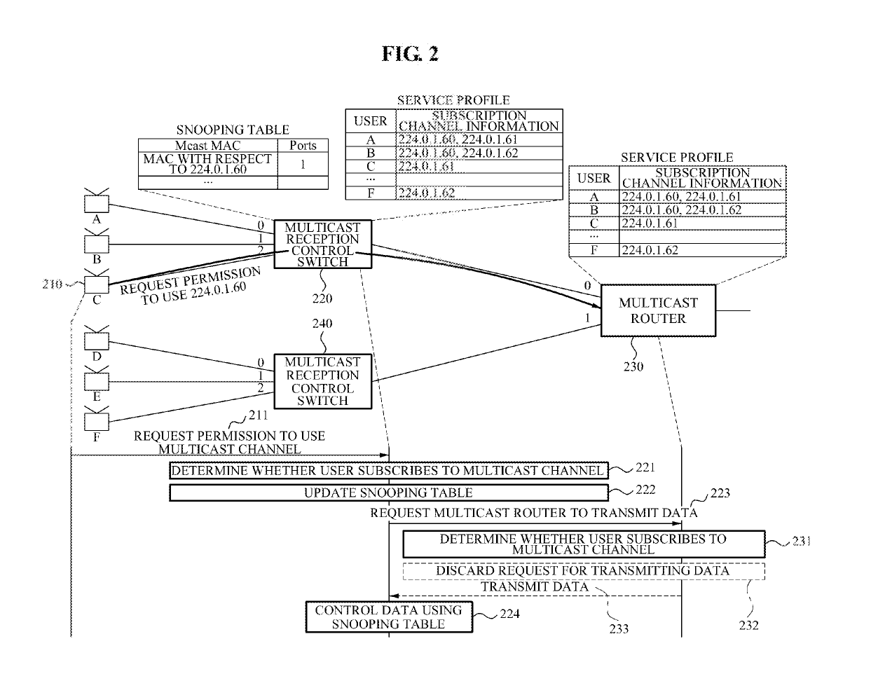

According to embodiments, an IP multicast service reception controlling method may be classified into two cases based on whether the multicast reception control switch includes a service profile including information associated with multicast channels to which each of a plurality of users is subscribed to. Each case may be classified into a case of performing passive snooping and a case of performing active snooping. Each case will be described in detail with reference to FIGS. 2 through 5.

<<Case 1: Multicast Reception Control Switch Includes a Service Profile>>

1. Where the Multicast Reception Control Switch Includes a Service Profile and Performs Passive Snooping

When the multicast reception control switch includes the service profile and performs passive snooping, the multicast reception control switch recognizes a content of a multicast control message exchanged between a user and a multicast router. The multicast reception control switch may only update a snooping table based on whether the user is subscribed to a corresponding multicast, channel using the service profile, and may not perform filtering with respect to the multicast control message.

When the user requests using a predetermined multicast channel, the multicast reception control switch may determine, based on the service profile, whether the user is subscribed to the predetermined multicast channel. When the user is not subscribed to the predetermined multicast channel, the multicast reception control switch may not add a port connected to the user, as a member of the predetermined multicast channel of the snooping table. Therefore, a user who is not subscribed to the predetermined multicast channel may not receive a service. In this example, members of each multicast channel may be managed for each multicast MAC address.

A multicast service reception request message from the user may be transmitted to the multicast router. The multicast router may also perform filtering with respect to the multicast service reception request message based on the service profile. The multicast router may discard a multicast service reception request message with respect to a multicast channel to which the user is not subscribed to and may only process a multicast service reception request message with respect to a multicast channel to which the user is subscribed to.

The service profile included in the multicast reception control switch and the multicast router may be set before the multicast service reception request message is received from the user, or may be obtained from an external service that processes channel subscription requests from users. The multicast reception control switch may obtain the service profile by exchanging a message with the multicast router via an interface.

An example thereof is described with reference to FIG. 2.

FIG. 2 illustrates an, example of controlling reception of an IP multicast service when a multicast reception control switch includes a service profile and performs passive snooping.

Referring to FIG. 2, two multicast reception control switches 220 and 240 are connected to a multicast router 230. The multicast reception control switch 220 includes a port 0, a port 1, and a port 2. The port 0 is connected to a user A, the port 1 is connected to a user B, and the port 2 is connected to a user C 210. The multicast reception control switch 240 includes a port 0, a port 1, and a port 2. The port 0 is connected to a user D, the port 1 is connected to a user E, and the port 2 is connected to a user F.

A multicast service reception control method may be described, in a view of the user C 210.

The user C 210 requests, from the reception control switch 220, permission to use a predetermined multicast channel (244.0.1.60) in operation 211. The request may be performed based on a multicast channel service reception request message, such as an ‘IGMP join’.

The multicast reception control switch 220 determines, based on a service profile, whether the user C 210 is subscribed to 244.0.1.60 in operation 221. The multicast reception control switch 220 may include the service profile. The multicast reception control switch 220 updates a snooping table based on the determination of operation 221, in operation 222. The user C 210 is not subscribed to 244.0.1.60 and thus, the multicast reception control switch 220 may not add, to the snooping table, the port 2 connected to the user C 210.

When the user C 210 is subscribed to 244.0.1.60, the multicast reception control switch 220 may add the user C 210 to the snooping table. The port 2 corresponding to the user C 210 may be added as a member of 244.0.1.60.

The multicast reception control switch 220 may request a multicast router 230 to transmit data with respect to 244.0.1.60 to the multicast reception control switch 220 in operation 223. The request may be performed by transmitting, to the multicast router 230, a multicast channel service reception request message received from the user C 210.

When the multicast router 230 receives the request for transmission of the data with respect to 244.0.1.60, the multicast router 230 determines whether the user C 210 is subscribed to 244.0.1.60 in operation 231. The user C 210 may not be subscribed to 244.0.1.60 and thus, the multicast router 230 discards the request for transmission of the data with respect to 244.0.1.60 in operation 232.

When the user C 210 is subscribed to 244.0.1.60, the multicast router 230 transmits, to the multicast reception control switch 220, the data with respect to 244.0.1.60 in operation 233.

The multicast reception control switch 220 controls data corresponding to each multicast channel through the snooping table in operation 224. The snooping table includes only the port 1 as a port to which the data with respect to 244.0.1.60 is to be transmitted and thus, the multicast reception control switch 220 may control the data to enable only the user A corresponding to the port 1 to receive the data with respect to 244.0.1.60. The user C 210 that is not subscribed to 244.0.1.60 may not receive the data with respect to 244.0.1.60.

2. Where the Multicast Reception Control Switch Includes a Service Profile and Performs Active Snooping

When the multicast reception control switch includes the service profile and performs active snooping, the multicast reception control switch may recognize a multicast control message exchanged between a user and a multicast router. The multicast reception control switch updates a snooping table based on whether the user is subscribed to a corresponding multicast channel, using the service profile. These operations are similar to the case of performing passive snooping. However, depending on circumstances, the multicast reception control switch performing the active snooping may not transmit the multicast control message to the multicast router.

For example, in a case of an IGMP, when a second user requests an JUMP join while a first user subscribing to a predetermined multicast channel has been requesting IGMP join from the multicast reception control switch, the multicast reception control switch may update information associated with the second user in a snooping table, and may not transmit, to the multicast router, the request from the second user for IGMP join. Data with respect to the predetermined multicast channel is being transmitted, from the multicast router, to the multicast reception control switch in response to the request from the first user and thus, there is no need to again transmit the request for IGMP join, to the multicast router. Therefore, unnecessary requests for data transmission to the multicast router may be reduced.

The multicast reception control switch and the multicast router in the case of performing active snooping may obtain the service profile in the same manner as the case of performing passive snooping.

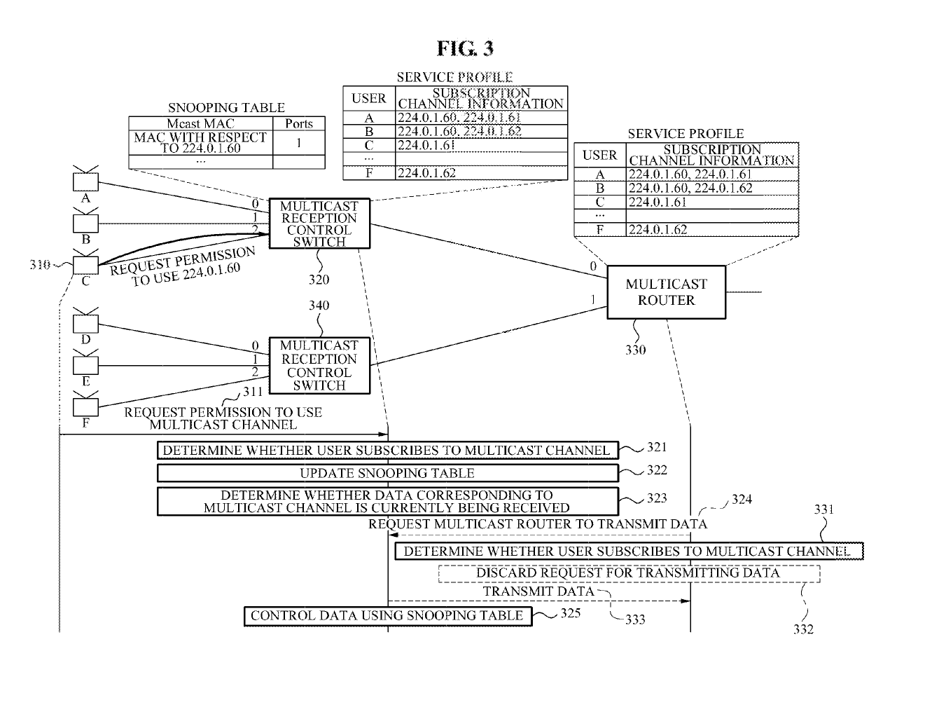

An example thereof may be described with reference to FIG. 3.

FIG. 3 illustrates an example of controlling reception of an IP multicast service when a multicast reception control switch includes a service profile and performs active snooping.

Referring to FIG. 3, two multicast reception control switches 320 and 340 are connected to a multicast router 330. The multicast reception control switch 320 includes a port 0, a port 1, and a port 2. The port 0 is connected to a user A, the port 1 is connected to a user B, and the port 2 is connected to a user C 310. The multicast reception control switch 340 includes a port 0, a port 1, and a port 2. The port 0 is connected to a user D, the port 1 is connected to a user E, and the port 2 is connected to a user F.

A multicast service reception control method may be described, in a view of the user C 310.

The user C 310 requests, from the reception control switch 320, permission to use a predetermined multicast channel (244.0.1.60) in operation 311. The request may be performed based on a multicast channel service reception request message, such as an ‘IGMP join’.

The multicast reception control switch 320 determines, based on a service profile, whether the user C 310 is subscribed to 244.0.1.60 in operation 321. The multicast reception control switch 320 may include the service profile. The multicast reception control switch 320 updates a snooping table based on the determination of operation 321, in operation 322. The user C 310 is not subscribed to 244.0.1.60 and thus, the multicast reception control switch 320 may not add, to the snooping table, the port 2 connected to the user C 310.

When the user C 310 is subscribed to 244.0.1.60, the multicast reception control switch 320 may add the user C 310 to the snooping table. The port 2 corresponding to the user C 310 may be added as a member of 244.0.1.60. The operations are similar to the case of performing passive snooping.

The multicast reception control switch 320 determines whether data corresponding to 244.0.1.60 that is the predetermined multicast channel for which the permission is requested by the user C 310 is currently being received from the multicast router 330 in operation 323. The multicast reception control switch 320 determines whether the data corresponding to 244.0.1.60 is currently being received in response to a request from another user. The determination may be performed based on the snooping table.

The data corresponding to 244.0.1.60 is currently being transmitted from the multicast router 330, to the multicast reception control switch 320, in response to a request from the user B. Therefore, the multicast reception control switch 320 may not transmit, to the multicast router 330, the request from the user C 310 for using the 244.0.1.60. Therefore, an unnecessary message transmission may be reduced.

The multicast reception control switch 320 controls data corresponding to each multicast channel using the snooping table in operation 325. The snooping table includes only the port 1 as a port to which the data with respect to 244.0.1.60 is to be transmitted and thus, the multicast reception control switch 320 may control the data to enable only the user A corresponding to the port 1 to receive the data with respect to 244.0.1.60. The user C 310 that is not subscribed to 244.0.1.60 may not receive the data with respect to 244.0.1.60.

When the data is not currently being received from the multicast router 330, the data corresponding to 244.0.1.60 that is the predetermined multicast channel for which the permission is requested by the user C 310, the multicast reception control switch 320 requests the multicast router 330 to transmit the data with respect to 244.0.1.60 to the multicast reception control switch 320 in operation 324, similar to the case of performing passive snooping. Subsequently, the multicast router determines whether the user is subscribed to 244.0.1.60 in operation 331. Based on the determination of operation 331, the multicast router may discard the request for transmitting the data in operation 332 or may transmit the data with respect to 244.0.1.60 to the multicast reception control switch 320 in operation 333, which are similar to the operations of the case of performing passive snooping of FIG. 2.

<<Case 2: Multicast Reception Control Switch does not Include a Service Profile>>

Even when the multicast reception control switch does not include the service profile, the multicast reception control switch updates a snooping table. However, unlike Case 1, when reception of service is requested, a corresponding user may be assumed to be an authorized user and may be added to the snooping table.

The multicast router determines whether a predetermined user is subscribed to a predetermined multicast channel based on the service profile. The multicast reception control switch may delete, from the snooping table, a port connected to the corresponding user, based on a control message from the multicast router, the control message being generated based on the determination.

1. Where the Multicast Reception Control Switch does not Include a Service Profile and Performs Passive Snooping

The multicast reception control switch performs snooping with respect to a multicast control message, such as a multicast service reception request message, a multicast service reception stop message, and the like. The multicast reception control switch does not include the service profile and thus, Case 2 may differently update the snooping table from Case 1. When the multicast reception control switch receives a request from a user for using a predetermined multicast channel, the user is assumed to be an authorized user and a port connected to the user is added to the snooping table as a member of the predetermined multicast channel.

The multicast reception control switch may transmit, to a multicast router, a multicast service reception request message from a predetermined user. The multicast router may perform filtering with respect to the multicast service reception request message, based on the service profile. The multicast router may discard a multicast service reception request message with respect to a multicast channel to which the user is not subscribed to and may only process a multicast service reception request message with respect to a multicast channel to which the user is subscribed to.

In this example, the multicast router discards the multicast service reception request message with respect to the multicast channel to which the user is not subscribed to, and may transmit, to the multicast reception control switch, a control message to correct the snooping table that is incorrectly updated with respect to the multicast channel to which the user is not subscribed to. The multicast reception control switch may delete, from the member of the multicast channel, the port corresponding to the user that is not subscribed to the multicast channel, based on the control message from the multicast router.

The service profiled included in the multicast router may be set before the multicast service reception request message is received from the user, or may be obtained from an external service that processes channel subscription requests from users.

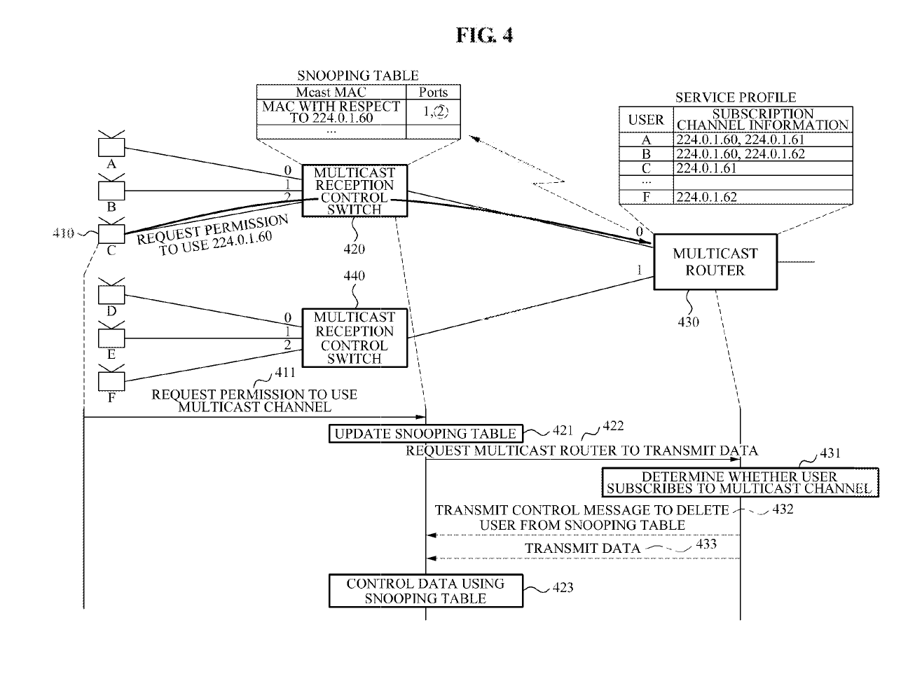

An example thereof may be described with reference to FIG. 4.

FIG. 4 illustrates an example of controlling reception of an IP multicast service when a multicast reception control switch does not include a service profile and performs passive snooping.

Referring to FIG. 4, two multicast reception control switches 420 and 440 are connected to a multicast router 430. The multicast reception control switch 420 includes a port 0, a port 1, and a port 2. The port 0 is connected to a user A, the port 1 is connected to a user B, and the port 2 is connected to a user C 410. The multicast reception control switch 440 includes, a port 0, a port 1, and a port 2. The port 0 is connected to a user D, the port 1 is connected to a user E, and the port 2 is connected to a user F.

A multicast service reception control method may be described in a view of the user C 410.

The user C 410 requests, from the reception control switch 420, permission to use a predetermined multicast channel (244.0.1.60) in operation 411. The request may be performed based on a multicast channel service reception request message, such as an ‘IGMP join’.

The multicast reception control switch 420 updates a snooping table in operation 421. In this example, unlike Case 1, the multicast reception control switch 420 does not include the service profile and thus, may not determine whether the user C 410 is subscribed to 244.0.1.60. Therefore, the multicast reception control switch 420 assumes the user C 410 as an authorized user and adds the user C 410 to the snooping table. The multicast reception control switch 420 may add, to the snooping table, the port 2 connected to the user C 410 as a member of 244.0.1.60.

The multicast reception control switch 420 may request the multicast router 430 to transmit the data with respect to 244.0.1.60 to the multicast reception control switch 420 in operation 422. The request may be performed by transmitting the multicast channel service reception request message received from the user C 410 to the multicast router 430.

When the multicast router 430 receives the request for transmitting data with respect to 244.0.1.60, the multicast router 430 determines whether the user C 410 is subscribed to 244.0.1.60 based on the service profile in operation 431.

When the user C 410 is not subscribed to 244.0.1.60, the multicast router 430 may transmit a control message to the multicast reception control switch 420, to delete the port 2 from the member of 244.0.1.60 of the snooping table in operation 432. The multicast reception control switch 420 may delete the port 2 from the snooping table based on the control message.

The multicast reception control switch 420 controls data corresponding to each multicast channel using the snooping table in operation 423. The snooping table includes only the port 1 as a port to which the data with respect to 244.0.1.60 is to be transmitted and thus, the multicast reception control switch 420 may control the data to enable only the user A corresponding to the port 1 to receive the data with respect to 244.0.1.60. The user C 410 that is not subscribed to 244.0.1.60 may not receive the data with respect to 244.0.1.60.

When the user C 410 is subscribed to 244.0.1.60, the multicast router 430 may transmit the data corresponding to 244.0.1.60 to the multicast reception control switch 420 to perform multicast routing in operation 433, as opposed to transmitting the control message used for deleting the user C 410 from the snooping table. The user C 410 may receive the data corresponding to 244.0.1.60.

2. Where the Multicast Reception Control Switch does not Include a Service Profile and performs active snooping

Unlike the case of performing passive snooping, the multicast reception control switch performing active snooping may not transmit, to the multicast router, the multicast service reception request message from the user.

When an authentic request for receiving a service with respect to the same multicast channel has been requested via the same multicast reception control switch, the multicast router may be transmitting data with respect to the corresponding multicast channel to the multicast reception control switch. Therefore, the multicast reception control switch may not request the multicast router to transmit the data although the multicast reception control switch receives a new reception request for receiving service with respect to the corresponding multicast channel. The multicast reception control switch may not transmit, to the multicast router, a new multicast service reception request message. Instead, the multicast reception control switch may request the multicast router to determine whether a new user is an authorized user. An authorized user may be a user that is subscribed to the corresponding multicast channel. The request for determining whether the user is an authorized user may be performed based on a separately defined control message. The multicast router may determine, based on the request for determining whether the user is an authorized user, whether the user requests reception of a multicast service.

When the multicast router receives the request for determining whether the user is an authorized user, the multicast router may determine whether the user is subscribed to the multicast channel based on the service profile. When the determination determines that the user is not subscribed to the multicast channel, the multicast router may transmit, to the multicast reception control switch, a control message used for correcting the snooping table that is incorrectly updated with respect to the multicast channel to which the user is not subscribed to. The multicast reception control switch may delete, from the snooping table, a port corresponding to the user that is not subscribed to the multicast channel, based on the control message from the multicast router.

The multicast router may obtain the service profile in the same manner as the case of performing passive snooping.

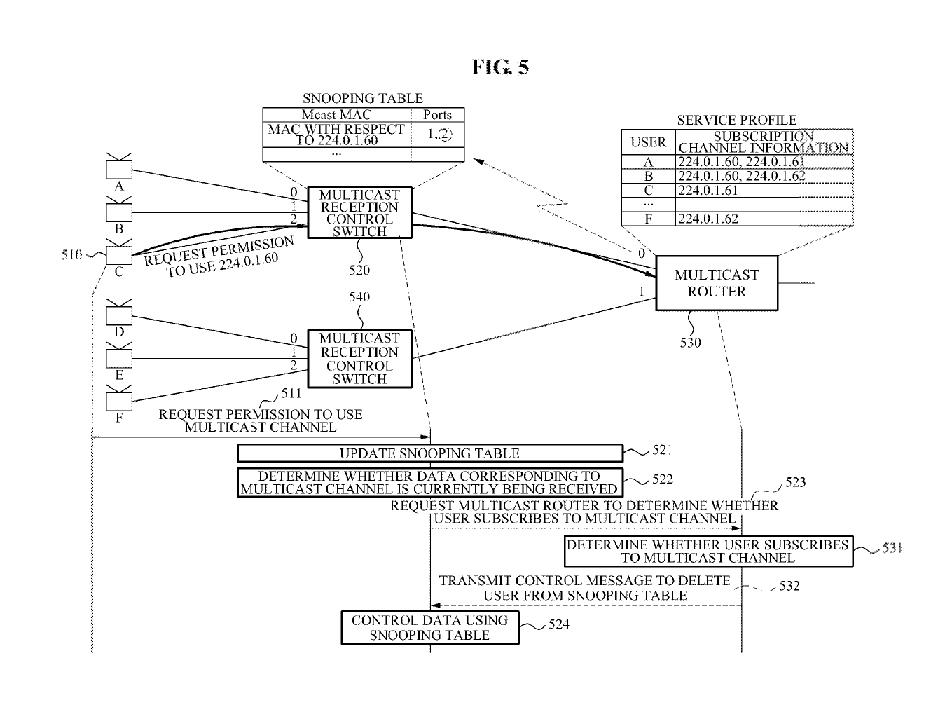

An example thereof may be described with reference to FIG. 5.

FIG. 5 illustrates an example of controlling of reception of an IP multicast service when a multicast reception control switch does not include a service profile and performs active snooping.

Referring to FIG. 5, two multicast reception control switches 520 and 540 are connected to a multicast router 530. The multicast reception control switch 520 includes a port 0, a port 1, and a port 2. The port 0 is connected to a user A, the port 1 is connected to a user B, and the port 2 is connected to a user C 510. The multicast reception control switch 540 includes a port 0, a port 1, and a port 2. The port 0 is connected to a user D, the port 1 is connected to a user E, and the port 2 is connected to a user F.

A multicast service reception control method may be described, in a view of the user C 510.

The user C 510 requests, from the multicast reception control switch 520, permission to use a predetermined multicast channel (244.0.1.60) in operation 511. The request may be performed based on a multicast channel service reception request message, such as an ‘IGMP join’.

The multicast reception control switch 520 updates a snooping table in operation 521. In this example, unlike Case 1, the multicast reception control switch 520 does not include the service profile and thus, may not determine whether the user C 510 is subscribed to 244.0.1.60. Therefore, the multicast reception control switch 520 assumes the user C 510 as an authorized user and adds the user C 510 to the snooping table. The multicast reception control switch 520 may add, to the snooping table, the port 2 connected to the user C 510 as a member of 244.0.1.60.

The multicast reception control switch 520 determines whether data corresponding to 244.0.1.60 that is the predetermined multicast channel for which the permission is requested by the user C 510 is currently being received from the multicast router 530 in operation 522. The multicast reception control switch 520 determines whether the data corresponding to 244.0.1.60 is currently being received based on a request from another user. The determination may be performed based on the snooping table.

The data corresponding to 244.0.1.60 is currently being transmitted, from the multicast router 530, to the multicast reception control switch 520, in response to a request from the user B. Therefore, the multicast reception control switch 520 may not transmit, to the multicast router 530, the request from the user C 510 for using the 244.0.1.60. Therefore, unnecessary message transmissions may be reduced. Instead, the multicast reception control switch 520 may request the multicast router 530 to determine whether the user C 510 is subscribed to 244.0.1.60 in operation 523. The request for the determination may be performed based on a separately defined control message.

When the multicast router 530 receives the request for determining whether the user C 510 is subscribed to 244.0.1.60, the multicast router 530 determines whether the user C 510 is subscribed to 244.0.1.60 based on the service profile in operation 531.

The user C 510 is not subscribed to 244.0.1.60 and thus, the multicast router 530 may transmit, to the multicast reception control switch 520, a control message to delete the port 2 from the member of 244.0.1.60 of the snooping table in operation 532. The multicast reception control switch 520 may delete the port 2 from the snooping table, based on the control message.

The multicast reception control switch 520 controls data corresponding to each multicast channel using the snooping table in operation 524. The snooping table includes only the port 1 as a port to which the data with respect to 244.0.1.60 is to be transmitted and thus, the multicast reception control switch 520 may control the data to enable only the user A corresponding to the port 1 to receive the data with respect to 244.0.1.60. The user C 510 who is not subscribed to 244.0.1.60 may not receive the data with respect to 244.0.1.60.

When the data corresponding to 244.0.1.60 that is the predetermined multicast channel for which the permission is requested by the user C 510, is not currently being received from the multicast router 530, the multicast reception control switch 520 may proceed with operation 522 and subsequent operations in the same manner as the case of performing passive snooping of FIG. 4, as opposed to requesting the multicast router to determine whether the user C 510 is subscribed to 244.0.1.60 of operation 523.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

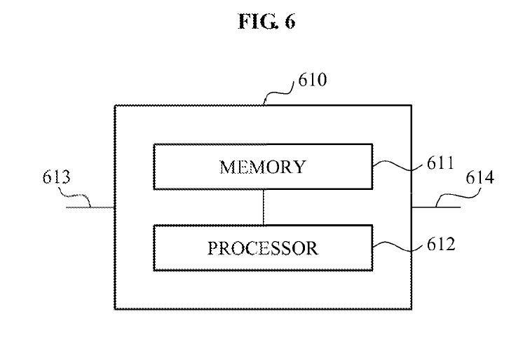

FIG. 6 illustrates a block diagram of a multicast reception control switch.

Referring to FIG. 6, the multicast reception control switch 610 may include a memory 611, a processor 612, a port 613 and a port 614.

The memory 611 may store a snooping table and a service profile including information associated with multicast channels to which each of plurality of users is subscribed to.

The processor 612 may determine whether a predetermined user is subscribed to a predetermined multicast channel based on the service profile, may update, in the snooping table based on the determination, information associated with the predetermined user, and may control, using the snooping table, data corresponding to the predetermined multicast channel, the data being transmitted from a multicast router.

The processor 612 may determine, based on the service profile, whether the predetermined user is subscribed to the predetermined multicast channel, in response to a request from the predetermined user for using the predetermined multicast channel.

In a case of performing passive snooping, the processor 612 may request the multicast router to transmit, to the multicast reception control switch, data corresponding to the predetermined multicast channel.

In a case of performing active snooping, the processor 612 may request the multicast router to transmit, to the multicast reception control switch, the data corresponding to the predetermined multicast channel based on whether the multicast reception control switch is currently receiving the data corresponding to the predetermined multicast channel from the multicast router.

The multicast router may transmit, based on the service profile and in response to the request from the multicast reception control switch, the data corresponding to the predetermined multicast channel to the multicast reception control switch.

The port 613 is connected to the predetermined user.

The port 614 is connected to the multicast router.

The multicast reception control switch according to embodiments has been described. Examples described with reference to FIGS. 1 through 5 may be applicable to the multicast reception control switch and thus, detailed description thereof may be omitted.

Although a few embodiments of the present invention have been shown and described, the present invention is not limited to the described embodiments. Instead, it to would be appreciated by those skilled in the art that changes may be made to these embodiments without departing from the principles and spirit of the invention, the scope of which is defined by the claims and their equivalents.

What is claimed is:

1. A multicast reception control switch, comprising:
a memory to store a snooping table and a service profile including information associated with multicast channels to which each of a plurality of users is subscribed to; and
a processor to determine, based on the service profile, whether a predetermined user is subscribed to a predetermined multicast channel, to update, in the snooping table, information associated with the predetermined user based on the determination, and to control, based on the snooping table, data corresponding to the predetermined multicast channel and being transmitted from a multicast router.

2. The multicast reception control switch of claim 1, wherein, in response to a request from the predetermined user for using the predetermined multicast channel, the processor determines, based on the service profile, whether the predetermined user is subscribed to the predetermined multicast channel.

3. The multicast reception control switch of claim 1, wherein the processor requests the multicast router to transmit the data corresponding to the predetermined multicast channel to the multicast reception control switch.

4. The multicast reception control switch of claim 1, wherein the processor requests the multicast router to transmit the data corresponding to the predetermined multicast channel to the multicast reception control switch based on whether the multicast reception control switch is currently receiving the data corresponding to the predetermined multicast channel from the multicast router.

5. The multicast reception control switch of claim 1, wherein the multicast router transmits, based on the service profile and in response to a request from the multicast reception control switch, the data corresponding to the predetermined multicast channel to the multicast reception control switch.

6. A multicast reception control switch, comprising:
a memory to store a snooping table; and
a processor to update, in the snooping table, information associated with a predetermined user, in response to a request from the predetermined user for using a predetermined multicast channel, to control, based on the snooping table, data corresponding to the predetermined multicast channel, and to update the snooping table based on a control message to delete information associated with the predetermined user, the control message being received from a multicast router and being based on whether the predetermined user is subscribed to the predetermined multicast channel.

7. The multicast reception control switch of claim 6, wherein the processor requests the multicast router to transmit the data corresponding to the predetermined multicast channel to the multicast reception control switch, in response to the request from the predetermined user for using the predetermined multicast channel.

8. The multicast reception control switch of claim 6, wherein the processor requests the multicast router to determine whether the predetermined user is subscribed to the predetermined multicast channel based on whether the multicast reception control switch is currently receiving the data corresponding to the predetermined multicast channel from the multicast router.

9. The multicast reception control switch of claim 6, wherein the processor receives the data corresponding to the predetermined multicast channel, based on a determination of the multicast router that determines whether the predetermined user is subscribed to the predetermined multicast based on a service profile including information associated with multicast channels to which each of a plurality of users is subscribed to.

10. A multicast router, comprising:
a processor to determine whether a predetermined user is subscribed to a predetermined multicast channel, based on a service profile including information associated with multicast channels to which each of a plurality of users is subscribed to and in response to a request from the multicast reception control switch, the request being with respect to a predetermined multicast channel of the predetermined user; and
a transmitting unit to transmit, based on the determination, data corresponding to the predetermined multicast channel to the multicast reception control switch.

11. The multicast router of claim 10, wherein:
the processor generates a control message to delete, from the snooping table, information associated with the predetermined user when the predetermined user is not subscribed to the predetermined multicast channel; and
the transmitting unit transmits the control message to the multicast reception control switch.

12. The multicast router of claim 10, further comprising:
a memory to store the service profile including the information associated with the multicast channels to which each of the plurality of users is subscribed to.

13. The multicast router of claim 12, wherein the memory obtains the service profile from an external server that processes channel subscription requests of the plurality of users.

14. The multicast router of claim 10, wherein the request from the multicast reception control switch is a request for transmitting the data corresponding to the predetermined multicast channel to the multicast reception control switch or a request for determining whether the predetermined user is subscribed to the predetermined multicast channel.

15. A method of controlling reception of an IP multicast service using a multicast reception control switch, the method comprising:
updating, by the multicast reception control switch, information associated with a predetermined user in a snooping table of the multicast reception control switch, in response to a request from the predetermined user for using a predetermined multicast channel;
determining, by the multicast router, whether the predetermined user is subscribed to the predetermined multicast channel, and transmitting data corresponding to the predetermined multicast channel to the multicast reception control switch based on the determination; and
controlling, by the multicast reception control switch, the data corresponding to the predetermined multicast channel based on the snooping table.

16. The method of claim 15, wherein the updating comprises:
updating the snooping table based on whether the predetermined user is subscribed to the predetermined multicast channel, using the service profile including the information associated with multicast channels to which each of a plurality of users is subscribed to.

17. The method of claim 15, further comprising:
requesting, by the multicast reception control switch, the multicast router to transmit, to the multicast reception control switch, the data corresponding to the predetermined multicast channel.

18. The method of claim 1.7, wherein the requesting comprises:
requesting, by the multicast reception control switch, the multicast router to transmit, to the multicast reception control switch, the data corresponding to the predetermined multicast channel, based on whether the multicast reception control switch is currently receiving the data corresponding to the predetermined multicast channel from the multicast router.

19. The method of claim 15, further comprising:
transmitting, by the multicast router, a control message to the multicast reception control switch to delete information associated with the predetermined user from the snooping table, when the predetermined user is not subscribed to the predetermined multicast channel; and
updating, by the multicast reception control switch, the snooping table based on the control message.
